(19) United States
(12) Patent Application Publication
(10) Pub. No.: US 2007/0099081 A1
(43) Pub. Date: May 3, 2007

(54) Non-aqueous electrolyte secondary battery

(76) Inventors: Hiroaki Matsuda, Osaka (JP); Sumihito Ishida, Osaka (JP)

Correspondence Address: MCDERMOTT WILL & EMERY LLP, 600 13TH STREET, N.W., WASHINGTON, DC, 20005-3096, US

(21) Appl. No.: 11/447,038

(22) Filed: Jun. 6, 2006

(30) Foreign Application Priority Data
Jun. 6, 2005 (JP) 2005-165114

(51) Int. Cl. H01M 4/62; H01M 4/40; H01M 4/58

(52) U.S. Cl. 429/217; 429/232; 429/231.95

(57) ABSTRACT

A non-aqueous electrolyte secondary battery including a positive electrode, a negative electrode, a separator interposed between the positive and negative electrodes, and a non-aqueous electrolyte. The negative electrode includes composite particles and a binder. Each of the composite particles includes: a negative electrode active material including an element capable of being alloyed with lithium; carbon nanofibers that are grown from a surface of the negative electrode active material; and a catalyst element for promoting the growth of the carbon nanofibers. The binder comprises at least one polymer selected from the group consisting of polyimide, polyamide imide, polyamide, aramid, polyarylate, polyether ether ketone, polyether imide, polyether sulfone, polysulfone, polyphenylene sulfide, and polytetrafluoroethylene.

### FIELD OF THE INVENTION

The present invention relates to non-aqueous electrolyte secondary batteries, and, more particularly, to the preferable combination of a negative electrode active material and a binder included in the negative electrode thereof.

### BACKGROUND OF THE INVENTION

Non-aqueous electrolyte secondary batteries are small and light-weight and have high energy densities. Thus, there is an increasing demand for non-aqueous electrolyte secondary batteries as appliances are becoming cordless and more portable.

Currently, negative electrode active materials used in non-aqueous electrolyte secondary batteries are mainly carbon materials (e.g., natural graphite, artificial graphite). Graphite has a theoretical capacity of 372 mAh/g. The capacities of negative electrode active materials comprising currently available carbon materials are approaching the theoretical capacity of graphite. It is therefore very difficult to further heighten the capacity by improving the carbon materials.

On the other hand, the capacities of materials comprising an element capable of being alloyed with lithium (e.g., Si, Sn) are significantly higher than the theoretical capacity of graphite. Hence, the materials comprising an element capable of being alloyed with lithium are expected as next-generation negative electrode active materials. However, these materials undergo significantly large volume changes when lithium is absorbed and released. Thus, when the charge/discharge cycle of the battery is repeated, the negative electrode active material repeatedly expands and contracts, so that the conductive network among the active material particles is cut. Therefore, charge/discharge cycling causes significantly large deterioration.

With the aim of improving the conductivity among the active material particles, it is proposed to coat the surface of the active material particles with carbon, which is a conductive material. It is also proposed to use highly conductive carbon nanotubes as a conductive agent. However, according to conventional proposals, it is difficult to obtain sufficient cycle characteristics when using a negative electrode active material comprising an element capable of being alloyed with lithium.

Under such circumstances, Japanese Laid-Open Patent Publication No. 2004-349056 proposes using composite particles as a negative electrode material. The composite particles include a negative electrode active material comprising an element capable of being alloyed with lithium, carbon nanofibers that are grown from the surface of the negative electrode active material, and a catalyst element for promoting the growth of the carbon nanofibers. It is becoming known that the use of such composite particles can provide high charge/discharge capacity and excellent cycle characteristics.

The negative electrode active material contained in the composite particles of Japanese Laid-Open Patent Publication No. 2004-349056 repeatedly expands and contracts during charge/discharge. However, the composite particles are composed of the active material particles chemically bonded to the carbon nanofibers, with the carbon nanofibers being entangled with one another. Thus, even when the expansion and contraction of the negative electrode active material is repeated, the electrical connection among the active material particles is sustained through the carbon nanofibers. Hence, the conductive network among the active material particles is less likely to be cut than conventional cases.

However, when such composite particles are used as a negative electrode material, the battery characteristics in a high-temperature environment may become lower than those when graphite is used. For example, when charged batteries including such composite particles are heated to 130° C., the battery temperature may further rise due to self-heating. Also, when charged batteries including such composite particles are stored in an environment at 85° C., the amount of gas produced inside the batteries may increase.

Such degradation in battery reliability in a high-temperature environment occurs even if the material comprising an element capable of being alloyed with lithium is changed. Hence, such degradation in reliability is ascribed to the catalyst element in the form of fine particles and the carbon nonofibers with large specific surface areas. Under a high-temperature environment, the catalyst element that activates various reactions and the carbon nonofibers with large reaction areas are believed to cause decomposition reaction of the non-aqueous electrolyte and deterioration of the binder.

It should be noted, however, that when a mere mixture of a material comprising an element capable of being alloyed with lithium and a common conductive agent (e.g., acetylene black) is used as the negative electrode material, such degradation in battery reliability in a high-temperature environment is negligible.

Meanwhile, the negative electrode of conventional non-aqueous electrolyte secondary batteries contains a common binder such as polyvinylidene fluoride or styrene butadiene rubber. However, the negative electrode containing polyvinylidene fluoride or styrene butadiene rubber cannot be heated to very high temperatures even in the drying step of removing water contained in the negative electrode before battery assembly. Also, when batteries are heated to high temperatures, polyvinylidene fluoride produces hydrofluoric acid, which may violently react with a negative electrode material (e.g., LiC₆). Therefore, for example, Japanese Laid-Open Patent Publication No. Hei 6-163031 proposes using polyimide as the negative electrode binder.

### BRIEF SUMMARY OF THE INVENTION

An object of the present invention is to provide a non-aqueous electrolyte secondary battery having excellent reliability in a high-temperature environment as well as a higher charge/discharge capacity than those using a graphite-based negative electrode active material.

The present invention relates to a non-aqueous electrolyte secondary battery including a positive electrode, a negative electrode, a separator interposed between the positive and negative electrodes, and a non-aqueous electrolyte. The negative electrode includes composite particles and a binder. Each of the composite particles includes: a negative electrode active material comprising an element capable of being alloyed with lithium; carbon nanofibers that are grown from a surface of the negative electrode active material; and a catalyst element for promoting the growth of the carbon nanofibers. The binder comprises at least one polymer selected from the group consisting of polyimide, polyamide imide, polyamide, aramid, polyarylate, polyether ether ketone, polyether imide, polyether sulfone, polysulfone, polyphenylene sulfide, and polytetrafluoroethylene.

The present invention also pertains to a negative electrode for a non-aqueous electrolyte secondary battery. The negative electrode includes composite particles and a binder. Each of the composite particles includes: a negative electrode active material comprising an element capable of being alloyed with lithium; carbon nanofibers that are grown from a surface of the negative electrode active material; and a catalyst element for promoting the growth of the carbon nanofibers. The binder comprises at least one polymer selected from the group consisting of polyimide, polyamide imide, polyamide, aramid, polyarylate, polyether ether ketone, polyether imide, polyether sulfone, polysulfone, polyphenylene sulfide, and polytetrafluoroethylene.

The element capable of being alloyed with lithium is preferably at least one selected from the group consisting of Si and Sn.

The negative electrode active material is preferably at least one selected from the group consisting of a simple substance of silicon, a silicon oxide, a silicon alloy, a simple substance of tin, a tin oxide, and a tin alloy.

The present invention can provide a non-aqueous electrolyte secondary battery having a higher charge/discharge capacity than those using a graphite-based negative electrode active material and good cycle characteristics. Also, the present invention can suppress a rise in battery temperature and an increase in gas production inside the battery even in a high-temperature environment. Therefore, the battery reliability is improved in a high-temperature environment.

The polymers as listed above have excellent chemical stability at high temperatures and are resistant to deterioration or degradation even when in contact with catalyst elements. Although the details are unknown, the binder comprising such a polymer is believed to be in contact with the catalyst element contained in the composite particles in the negative electrode. However, even if the binder is in contact with the catalyst element in a high-temperature environment, it is believed that the adhesive properties of the binder are unlikely to deteriorate and that the contact between the binder and the catalyst element is maintained. Therefore, the contact between the catalyst element that may cause various side reactions and other battery components (particularly non-aqueous electrolyte) is reduced, and side reactions are prevented from occurring in a high-temperature environment.

Accordingly, the present invention can provide a non-aqueous electrolyte secondary battery that has both high charge/discharge capacity and good cycle characteristics while having excellent reliability in a high-temperature environment.

### BRIEF DESCRIPTION OF THE SEVERAL VIEWS OF THE DRAWING

FIG. 1 is a schematic view showing one form of composite particles contained in a negative electrode according to the present invention; and

FIG. 2 is a longitudinal sectional view of an exemplary non-aqueous electrolyte secondary battery according to the present invention.

### DETAILED DESCRIPTION OF THE INVENTION

A non-aqueous electrolyte secondary battery according to the present invention includes a positive electrode, a negative electrode, a separator interposed between the positive and negative electrodes, and a non-aqueous electrolyte. The negative electrode includes composite particles and a binder.

Each of the composite particles includes: a negative electrode active material comprising an element capable of being alloyed with lithium; carbon nanofibers that are grown from the surface of the negative electrode active material; and a catalyst element for promoting the growth of the carbon nanofibers. The composite particles can be obtained by placing a catalyst element on the surface of a negative electrode active material and growing carbon nanofibers from the surface of the negative electrode active material.

Exemplary elements capable of being alloyed with lithium include, but are not particularly limited to, Al, Si, Zn, Ge, Cd, Sn, and Pb. These elements may be contained in the negative electrode active material singly or in combination of two or more of them. Among them, for example, Si and Sn are particularly preferred. Si-containing negative electrode active materials and Sn-containing negative electrode active materials are advantageous, since they particularly have high capacities. Such negative electrode active materials comprising an element capable of being alloyed with lithium may be used singly or in combination of two or more of them. It is also possible to use a combination of a negative electrode active material comprising an element capable of being alloyed with lithium and a negative electrode active material containing no element capable of being alloyed with lithium (e.g., graphite). However, in order to obtain a sufficiently high capacity, the negative electrode active material comprising an element capable of being alloyed with lithium desirably accounts for 50% by weight or more of the total of the negative electrode active materials.

Exemplary Si-containing negative electrode active materials include, but are not particularly limited to, a simple substance of silicon, silicon oxides, and silicon alloys. An exemplary silicon oxide may be SiO. (0<x<2, preferably 0.1≦x≦1). An exemplary silicon alloy may be an alloy containing Si and a transition metal element M (M-Si alloy). For example, the use of a Ni—Si alloy or Ti—Si alloy is preferred.

Exemplary Sn-containing negative electrode active materials include, but are not particularly limited to, a simple substance of tin, tin oxides, and tin alloys. An exemplary tin oxide may be SnO. (0<x≦2). An exemplary tin alloy may be an alloy containing Sn and a transition metal element M (M-Sn alloy). For example, the use of a Mg—Sn alloy or Fe—Sn alloy is preferred.

The particle size of the negative electrode active material comprising an element capable of being alloyed with lithium is not particularly limited, but it is preferably 0.1 μm to 100 μm, and particularly preferably 0.5 μm to 50 μm. If the mean particle size is smaller than 0.1 μm, the specific surface area of the negative electrode active material increases, which may result in an increase in irreversible capacity on the initial charge/discharge. Also, if the mean particle size exceeds 100 μm, the active material particles are susceptible to crushing due to charge/discharge. The mean particle size of the negative electrode active material can be measured with a laser diffraction particle size analyzer (e.g., SALD-2200, available from Shimadzu Corporation). In this case, the median diameter (D50) in volume-basis particle size distribution is the mean particle size.

Exemplary catalyst elements for promoting the growth of carbon nanofibers are not particularly limited and include various transition metal elements. Particularly, it is preferred to use at least one selected from the group consisting of Mn, Fe, Co, Ni, Cu, and Mo as the catalyst element. They may be used singly or in combination of two or more of them.

Methods for placing such a catalyst element on the surface of the negative electrode active material are not particularly limited, and an example is an immersion method. According to the immersion method, a solution of a compound containing a catalyst element (e.g., an oxide, a carbide, or a nitrate) is prepared. Exemplary compounds containing a catalyst element include, but are not particularly limited to, nickel nitrate, cobalt nitrate, iron nitrate, copper nitrate, manganese nitrate, and hexaammonium heptamolybdate. Among them, particularly nickel nitrate, cobalt nitrate and the like are preferred. Exemplary solvents for the solution include water, organic solvents, mixtures of water and an organic solvent. Exemplary organic solvents include ethanol, isopropyl alcohol, toluene, benzene, hexane, and tetrahydrofuran.

Next, a negative electrode active material is immersed in the resultant solution. Then, the solvent is removed from the negative electrode active material, and if necessary, a heat-treatment is applied. As a result, particles comprising the catalyst element (hereinafter referred to as catalyst particles) can be carried on the surface of the negative electrode active material in such a manner that they are uniformly and highly dispersed.

The amount of the catalyst element carried on the negative electrode active material is desirably 0.01 to 10 parts by weight, more desirably 1 to 3 parts by weight, per 100 parts by weight of the negative electrode active material. In the case of using a compound containing the catalyst element, adjustment is made such that the amount of the catalyst element contained in the compound is within the above-mentioned range. If the amount of the catalyst element is less than 0.01 part by weight, it takes a long time to grow carbon nanofibers, thereby resulting in a decrease in production efficiency. If the amount of the catalyst element exceeds 10 parts by weight, agglomeration of catalyst particles occurs so that carbon nanofibers with uneven and large diameters are grown. Hence, the electrode conductivity and active material density decrease.

The size of the catalyst particles is preferably 1 nm to 1000 nm, and more preferably 10 nm to 100 nm. It is very difficult to produce catalyst particles with a size of less than 1 nm. On the other hand, if the size of the catalyst particles exceeds 1000 nm, the catalyst particles are extremely uneven in size, so that it is difficult to grow carbon nanofibers.

An exemplary method for growing carbon nanofibers from the surface of a negative electrode active material carrying a catalyst element is described below.

First, a negative electrode active material with a catalyst element carried thereon is heated to the temperature range of 100° C. to 1000° C. in an inert gas. Then, a mixture of carbon-atom-containing gas and hydrogen gas is introduced to the surface of the negative electrode active material. The carbon-atom-containing gas may be, for example, methane, ethane, ethylene, butane, carbon monoxide, or the like. They may be used singly or in combination of two or more of them. By the introduction of the mixed gas, the catalyst element is reduced, so that carbon nanofibers are grown to form composite particles. When the negative electrode active material has no catalyst element on the surface thereof, no growth of carbon nanofibers is observed. During the growth of carbon nanofibers, the catalyst element is desirably in the form of metal.

The composite particles thus obtained are preferably heat-treated at 400° C. to 1600° C. in an inert gas. By applying such a heat-treatment, the irreversible reaction between the non-aqueous electrolyte and the carbon nanofibers is reduced during the initial charge/discharge, thereby resulting in an improvement in charge/discharge efficiency.

The length of the carbon nanofibers is preferably 10 nm to 1000 μm, and more preferably 500 nm to 500 μm. If the length of the carbon nanofibers is less than 10 nm, the effect of maintaining the conductive network among the active material particles decreases. On the other hand, if the fiber length exceeds 1000 μm, the active material density of the negative electrode lowers, so that a high energy density may not be obtained. Also, the diameter of the carbon nanofibers is preferably 1 nm to 1000 nm, and more preferably 50 nm to 300 nm. However, some of the carbon nanofibers are preferably fine fibers with a diameter of 1 nm to 40 nm in terms of improving the electronic conductivity of the negative electrode. For example, the carbon nanofibers preferably include fine carbon nanofibers with a diameter of 40 nm or less and large carbon nanofibers with a diameter of 50 nm or more. Further, the carbon nanofibers more preferably include fine carbon nanofibers with a diameter of 20 nm or less and large carbon nanofibers with a diameter of 80 nm or more.

The amount of the carbon nanofibers grown on the surface of the negative electrode active material is preferably 5 to 70% by weight, and more preferably 10 to 40% by weight, of the whole composite particles. If the amount of the carbon nanofibers is less than 5% by weight, the effect of maintaining the conductive network among the active material particles decreases, for example. If the amount of the carbon nanofibers exceeds 70% by weight, the active material density of the negative electrode lowers, so that a high energy density may not be obtained.

The shape of the carbon nanofibers is not particularly limited, and the carbon nanofibers may be in the shape of, for example, tubes, accordion-pleats, plates, or herringbones.

The negative electrode contains a binder in addition to the composite particles. The binder comprises at least one heat-resistant polymer selected from the group consisting of polyimide, polyamide imide, polyamide, aramid, polyarylate, polyether ether ketone, polyether imide, polyether sulfone, polysulfone, polyphenylene sulfide, and polytetrafluoroethylene. These polymers have excellent chemical stability at high temperatures. Among them, for example, polyimide and polyamide imide are particularly preferred since they have high chemical stability and adhesive properties. These polymers may be used singly or in combination of one or more of them.

The heat-resistant polymer used as the binder desirably has a heat resistance to 150° C. or higher. As used herein, heat resistance refers to continuous service temperature that is determined in accordance with UL 746, a test standard defined by American testing and certification organization: Underwriters Laboratories Inc. (UL).

The negative electrode binder may contain other polymers than the above-listed heat-resistant polymers, but the heat-resistant polymer preferably constitutes not less than 80% by weight of the whole binder. If the heat-resistant polymer constitutes less than 80% by weight, it may not produce the effect of improving battery reliability in a high-temperature environment.

The amount of the negative electrode binder is preferably 0.5 to 30 parts by weight, more preferably, 1 to 20 parts by weight, per 100 parts by weight of the composite particles. If the amount of the binder is less than 0.5 part by weight, the composite particles may not be sufficiently bound together. Also, if the amount of the binder exceeds 30 parts by weight, a sufficiently high capacity may not be obtained.

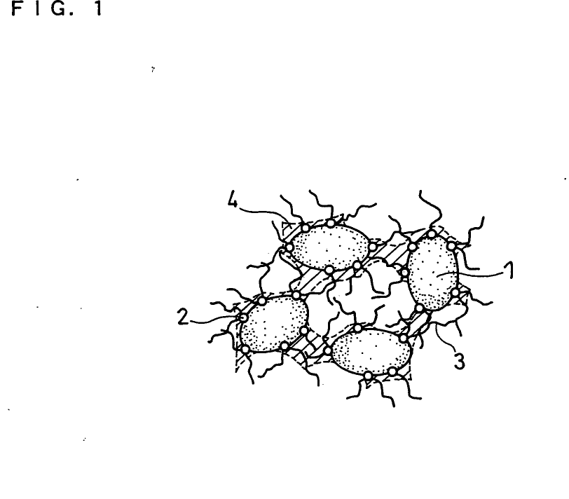

FIG. 1 schematically illustrates one form of composite particles mixed with a binder.

Composite particles 10 include a negative electrode active material 11, catalyst particles 12 on the surface of the negative electrode active material 11, and carbon nanofibers 13 that are grown from the catalyst particles 12 on the surface of the negative electrode active material 11. A binder 14 has the function of binding the composite particles 10 together, as illustrated in FIG. 1, and in addition, has the function of binding the composite particles 10 to a current collector. Such composite particles as in FIG. 1 can be obtained when carbon nanofibers grow without causing the catalyst element to be separated from the negative electrode active material. However, the growth of carbon nanofibers may involve separation of the catalyst element from the negative electrode active material. In this case, the catalyst particles are present at the growing end of the carbon nanofibers, i.e., the free end thereof.

In the composite particles, the bond between the carbon nanofibers and the negative electrode active material is a chemical bond (e.g., covalent bond, ionic bond). That is, the carbon nanofibers are directly bound to the surface of the negative electrode active material. Hence, even when the active material repeatedly expands and contracts significantly during charge/discharge, the contact between the carbon nanofibers and the active material is constantly maintained.

The negative electrode is produced by applying a negative electrode mixture containing the composite particles and the binder as essential components onto a current collector. The negative electrode mixture may contain optional components such as a conductive agent. Exemplary conductive agents include graphite, acetylene black, and common carbon fibers.

The method for producing the negative electrode is not particularly limited, but an exemplary method is as follows. Composite particles are dispersed in a liquid component in which a binder is dissolved or dispersed so as to form a negative electrode mixture paste, which is applied onto a current collector. The current collector is, for example, a metal foil such as copper foil. The paste applied to the current collector is dried and rolled to produce a negative electrode.

In preparing the negative electrode mixture paste, it is desirable to dissolve or disperse a binder whose polymerization has been completed or a precursor of a binder before polymerization in a liquid component and mix it with the composite particles. That is, when the binder is mixed with the composite particles, the binder may be in the state of a precursor before polymerization. However, when a precursor is used, polymerization reaction of the precursor needs to be completed by heat-treating the negative electrode mixture paste applied to a current collector. Thus, an additive for promoting the polymerization reaction may be mixed into the negative electrode mixture paste.

Some binders comprising the above-mentioned heat-resistant polymers are difficult to dissolve in a solvent after the polymerization is completed, or have poor adhesive properties when used singly. In such cases, an additive for improving the dissolution, adhesive properties, etc. of the binder may be mixed into the negative electrode mixture paste, if necessary, unless the effects of the present invention are not impaired. Also, the above-mentioned heat-resistant polymers may be copolymerized with not more than 20% by weight of a given monomer.

The liquid component in which the binder or precursor thereof is dissolved or dispersed may be selected appropriately in view of, for example, the compatibility with the binder. The liquid component is not particularly limited, and examples include N,N-dimethylformamide, N-methyl-2-pyrrolidone, and N,N-dimethyl acetamide. They may be used singly or in combination of two or more of them.

Binders comprising the above-mentioned heat-resistant polymers can be synthesized by known techniques in the art.

Next, an exemplary method for producing the negative electrode by using a polyimide binder is specifically described below.

First, a solution of polyamic acid composed of a carboxylic acid anhydride component and a diamine component is prepared. Polyamic acid is a precursor of polyimide. The, polyamic acid solution is mixed with the composite particles, to form a negative electrode mixture paste. The negative electrode mixture paste is applied onto a current collector and then heat-treated at 80° C. to 450° C. in an inert gas. This heat-treatment causes imidization (polymerization reaction) of the precursor to proceed. However, this heat-treatment may be omitted depending on the kind of the precursor.

Exemplary carboxylic acid anhydride components of polyamic acid include pyromellitic dianhydride, benzophenone tetracarboxylic dianhydride, and biphenyl tetracarboxylic dianhydride. They may be used singly or in combination of two or more of them. Also, exemplary diamine components include paraphenylenediamine, 4,4′-diaminodiphenylmethane, and 4,4′-diaminodiphenylether. They may be used singly or in combination of two or more of them. It should be noted, however, that the carboxylic acid anhydride component and diamine component are not limited to those as listed above.

Preferable commercial products that may be used as solutions of a binder comprising such a heat-resistant polymer or a precursor thereof include: polyimide precursor solution “U-Varnish (trade name)” (available from Ube Industries, Ltd.); polyamide imide solution “VYLOMAX (trade name)” (available from Toyobo co., Ltd.); N-methyl-2-pyrrolidone solution of polyarylate “U Polymer (trade name)” (available from Unitika Ltd.); N-methyl-2-pyrrolidone solution of polyether imide “ULTEM (trade name)” (available from Japan GE Plastics); and N-methyl-2-pyrrolidone solution of polyether sulfone “SUMIKA Excel (trade name)” (available from Sumitomo Chemical Co., Ltd.).

The non-aqueous electrolyte secondary battery of the present invention is not particularly limited except for the use of the negative electrode as described above. Thus, the structure of the positive electrode, the kind of the separator, the composition of the non-aqueous electrolyte, the fabrication method of the non-aqueous electrolyte secondary battery, etc., are arbitrary.

The positive electrode includes a positive electrode active material comprising, for example, a lithium-containing transition metal oxide. The lithium-containing transition metal oxide is not particularly limited, but oxides represented by LiMO₂ (M is one or more selected from V, Cr, Mn, Fe, Co, Ni, and the like) and LiMn₂O₄ are preferably used. Among them, for example, LiCoO₂, LiNiO₂, and LiMn₂O₄ are preferred. It is preferred that a part of the transition metal contained in these oxides be replaced with Al or Mg.

The positive electrode is produced, for example, by applying a positive electrode mixture containing a positive electrode active material as an essential component onto a current collector. The positive electrode mixture may contain optional components such as a binder or a conductive agent. Exemplary conductive agents include graphite, acetylene black, and common carbon fibers. Exemplary binders include polyvinylidene fluoride and styrene butadiene rubber.

The method for producing the positive electrode is not particularly limited, but an exemplary method is as follows. A positive electrode active material and a conductive agent are dispersed in a liquid component in which a binder is dissolved or dispersed so as to form a positive electrode mixture paste, which is applied onto a current collector. The current collector is, for example, a metal foil such as aluminum foil. The paste applied to the current collector is dried and rolled, to form a positive electrode.

The separator is not particularly limited, but the use of a microporous film made of polyolefin resin is preferred. The polyolefin resin is preferably polyethylene or polypropylene.

The non-aqueous electrolyte preferably comprises a non-aqueous solvent with a lithium salt dissolved therein. The lithium salt is not particularly limited, but preferable examples include LiPF₆, LiClO₄, and LiBF₄. They may be used singly or in combination of two or more of them. The non-aqueous solvent is not particularly limited, but preferable examples include ethylene carbonate, propylene carbonate, dimethyl carbonate, ethyl methyl carbonate, diethyl carbonate, Y-butyrolactone, tetrahydrofuran, and 1,2-dimethoxyethane. They may be used singly or in combination of two or more of them. The non-aqueous electrolyte may further contain an additive such as vinylene carbonate or cyclohexyl benzene.

The shape and size of non-aqueous electrolyte secondary batteries are not particularly limited. The present invention is applicable to non-aqueous electrolyte secondary batteries of various shapes, such as cylindrical or prismatic type.

The present invention is hereinafter described specifically by way of Examples. These Examples, however, are not to be construed as limiting in any way the present invention.

### EXAMPLE 1

Silicon monoxide powder (reagent, available from Wako Pure Chemical Industries, Ltd.) was pulverized in advance and classified into a particle size of 10 μm or less (mean particle size 5 μm). 100 parts by weight of this silicon monoxide powder (hereinafter also referred to as SiO powder-1) was mixed with 1 part by weight of nickel (II) nitrate hexahydrate (guaranteed reagent, available from Kanto Chemical Co., Inc.) and a suitable amount of ion-exchange water (solvent). The resultant mixture was stirred for 1 hour, and then dried in an evaporator to remove the solvent. As a result, catalyst particles comprising nickel (II) nitrate were carried on the surfaces of the SiO particles (active material). When the surfaces of the SiO particles were analyzed with an SEM, it was confirmed that the nickel (II) nitrate was in the form of particles with a size of approximately 100 nm.

The SiO particles with the catalyst particles carried thereon were placed into a ceramic reaction container and heated to 550° C. in helium gas. The helium gas was then replaced with a mixture of 50% hydrogen gas and 50% ethylene gas. The internal temperature of the reaction container filled with the mixed gas was maintained at 550° C. for 1 hour, so that the nickel (II) nitrate was reduced and carbon nanofibers were grown. Thereafter, the mixed gas was replaced with helium gas, and the interior of the reaction container was cooled to room temperature.

The resultant composite particles were placed in argon gas at 700° C. for 1 hour to heat-treat the carbon nanofibers. When the composite particles were analyzed with an SEM, it was confirmed that carbon nanofibers with a diameter of approximately 80 nm and a length of approximately 100 μm were grown on the surfaces of the SiO particles.

The amount of the grown carbon nanofibers was approximately 30% by weight of the whole composite particles.

A binder solution containing 15% by weight of a polyimide precursor was prepared by diluting a polyimide precursor solution “U-Varnish A (trade name)” (available from Ube Industries, Ltd.) with N-methyl-2-pyrrolidone (NMP). 100 parts by weight of the composite particles were sufficiently mixed with the binder solution containing 8 parts by weight of the polyimide precursor and a suitable amount of NMP, to form a negative electrode mixture paste. The negative electrode mixture paste was applied onto both sides of a 15-μm-thick Cu foil serving as a current collector and dried. The dried negative electrode mixture was heat-treated at 350° C. in argon gas to polymerize the polyimide precursor. Thereafter, the negative electrode mixture was rolled to obtain a negative electrode. The continuous service temperature of the resultant polyimide determined according to UL 746 was 260° C.

### EXAMPLE 2

A negative electrode was produced in the same manner as in Example 1, except for the use of silicon (Si) powder with a mean particle size of 5 μm (reagent, available from Wako Pure Chemical Industries, Ltd.) instead of the silicon monoxide powder. The size of the nickel (II) nitrate catalyst particles carried on the surfaces of the Si particles, and the diameter, length and amount of the grown carbon nanofibers were almost the same as those in Example 1.

### EXAMPLE 3

A negative electrode was produced in the same manner as in Example 1 except for the use of tin (IV) oxide (SnO₂) powder with a mean particle size of 5 μm (guaranteed reagent, available from Kanto Chemical Co., Inc.) instead of the silicon monoxide powder. The size of the nickel (II) nitrate catalyst particles carried on the surfaces of the SnO₂ particles, and the diameter, length and amount of the grown carbon nanofibers were almost the same as those in Example 1.

### EXAMPLE 4

A negative electrode was produced in the same manner as in Example 1, except for the use of a Ni—Si alloy with a mean particle size of 5 μm instead of the silicon monoxide powder. The size of the nickel (II) nitrate catalyst particles carried on the surfaces of the Ni—Si alloy particles, and the diameter, length and amount of the grown carbon nanofibers were almost the same as those in Example 1.

The Ni—Si alloy was produced in the following manner. 60 parts by weight of nickel powder (reagent, particle size 150 μm or less, available from Japan Pure Chemical Co., Ltd.) was mixed with 100 parts by weight of silicon powder (reagent, available from Wako Pure Chemical Industries, Ltd.). The resultant mixture of 3.5 kg was placed in a vibration mill, and stainless steel balls (diameter 2 cm) were placed therein such that they occupied 70% of the volume inside the mill. Mechanical alloying was performed in argon gas for 80 hours, to obtain a Ni—Si alloy.

The resultant Ni-Si alloy was observed with an XRD, TEM and the like. As a result, the alloy was found to have an amorphous phase, as well as a microcrystalline Si phase and a microcrystalline NiSi₂ phase, each microcrystal being approximately 10 nm to 20 nm. On the assumption that the alloy is composed only of Si and NiSi₂, the Si:NiSi₂ weight ratio was approximately 30:70, although the weight ratio of Si and Ni contained in the amorphous phase is unidentified.

### EXAMPLE 5

A negative electrode was produced in the same manner as in Example 1, except for the use of a Ti—Si alloy with a mean particle size of 5 μm instead of the silicon monoxide powder. The size of the nickel (II) nitrate catalyst particles carried on the surfaces of the Ti—Si alloy particles, and the diameter, length and amount of the grown carbon nanofibers were almost the same as those in Example 1.

The Ti—Si alloy was produced in the same manner as in Example 4, except for the use of 50 parts by weight of titanium powder (reagent, particle size 150 μm or less, available from Japan Pure Chemical Co., Ltd.) instead of the 60 parts by weight of nickel powder. In the same manner as the Ni—Si alloy, the Ti—Si alloy was also found to have an amorphous phase, a microcrystalline Si phase, and a microcrystalline TiSi₂ phase, each microcrystal being approximately 10 nm to 20 nm. On the assumption that the alloy is composed only of Si and TiSi₂, the Si:TiSi₂ weight ratio was approximately 25:75.

### EXAMPLE 6

100 parts by weight of composite particles produced in the same manner as Example 1 were sufficiently mixed with a binder solution containing 8 parts by weight of polyamide imide and a suitable amount of NMP, to form a negative electrode mixture paste. The binder solution used was VYLOMAX, HR11NN (trade name) available from Toyobo co., Ltd. The negative electrode mixture paste was applied onto both sides of a 15-μm-thick Cu foil serving as a current collector, dried, and rolled to obtain a negative electrode. The continuous service temperature of the polyamide imide according to UL 746 was 250° C.

### EXAMPLE 7

A binder solution containing 15% by weight of polyarylate was prepared by dissolving polyarylate “U Polymer U-100 (trade name)” (available from Unitika Ltd.) in NMP.

100 parts by weight of composite particles produced in the same manner as in Example 1 were sufficiently mixed with the binder solution containing 8 parts by weight of polyarylate and a suitable amount of NMP, to form a negative electrode mixture paste. The negative electrode mixture paste was applied onto both sides of a 15-μm-thick Cu foil serving as a current collector, dried, and rolled to obtain a negative electrode. The continuous service temperature of the polyarylate according to UL 746 was 180° C.

### EXAMPLE 8

A binder solution containing 15% by weight of polyether imide was prepared by dissolving polyether imide “ULTEM 1000 (trade name)” (available from Japan GE Plastics) in NMP.

100 parts by weight of composite particles produced in the same manner as in Example 1 were sufficiently mixed with the binder solution containing 8 parts by weight of polyether imide and a suitable amount of NMP, to form a negative electrode mixture paste. The negative electrode mixture paste was applied onto both sides of a 15-μm-thick Cu foil serving as a current collector, dried, and rolled to obtain a negative electrode. The continuous service temperature of the polyether imide according to UL 746 was 170° C.

### EXAMPLE 9

A binder solution containing 15% by weight of polyether sulfone was prepared by dissolving polyether sulfone powder “SUMIKA Excel 4800P (trade name)” (available from Sumitomo Chemical Co., Ltd.) in NMP.

100 parts by weight of composite particles produced in the same manner as in Example 1 were sufficiently mixed with the binder solution containing 8 parts by weight of polyether sulfone and a suitable amount of NMP, to form a negative electrode mixture paste. The negative electrode mixture paste was applied onto both sides of a 15-μm-thick Cu foil serving as a current collector, dried, and rolled to obtain a negative electrode. The continuous service temperature of the polyether sulfone according to UL 746 was 180° C.

### EXAMPLE 10

A binder solution containing aramid was prepared in the following procedure.

6.5 parts by weight of calcium chloride (guaranteed reagent, available from Kanto Chemical Co., Inc.) was added to 100 parts by weight of NMP, and was dissolved completely by heating. The resultant calcium chloride solution was allowed to cool to room temperature. Thereafter, 3.2 parts by weight of paraphenylenediamine (reagent, available from Sigma-Aldrich Corporation) was added to this solution and completely dissolved. The resultant paraphenylenediamine solution was placed into a constant temperature room at 20° C., and 5.8 parts by weight of terephthalic acid dichloride (reagent, available from Sigma-Aldrich Corporation) was added dropwise thereto, to form an aramid solution. The resultant aramid solution was diluted with MP, to prepare a binder solution containing 15% by weight of aramid.

100 parts by weight of composite particles produced in the same manner as in Example 1 were sufficiently mixed with the binder solution containing 8 parts by weight of aramid and a suitable amount of NMP, to form a negative electrode mixture paste. The negative electrode mixture paste was applied onto both sides of a 15-μm-thick Cu foil serving as a current collector, dried, and rolled to obtain a negative electrode. The continuous service temperature of the aramid according to UL 746 was 220° C.

### EXAMPLE 11

100 parts by weight of polyether sulfone powder “SUMIKA EXCEL 4800P (trade name)” (available from Sumitomo Chemical Co., Ltd.) was mixed with 100 parts by weight of polyether ether ketone powder “PEEK polymer 150 PF (trade name)” (available from Victrex-MC Inc.). The resultant mixture was pulverized and kneaded with a wet ball mill using ion-exchange water as the dispersion medium, to form a binder emulsion.

100 parts by weight of composite particles produced in the same manner as in Example 1 were sufficiently mixed with the binder emulsion containing a total of 8 parts by weight of polyether sulfone and polyether ether ketone and a suitable amount of ion-exchange water, to form a negative electrode mixture paste. The negative electrode mixture paste was applied onto both sides of a 15-μm-thick Cu foil serving as a current collector, dried, and rolled to obtain a negative electrode. The continuous service temperature of the polyether ether ketone according to UL 746 was 240° C.

### EXAMPLE 12

A negative electrode was produced in the same manner as in Example 1, except for the use of cobalt (II) nitrate hexahydrate (guaranteed reagent, available from Kanto Chemical Co., Inc.) instead of the nickel (II) nitrate hexahydrate. The size of cobalt (II) nitrate catalyst particles carried on the surfaces of the SiO particles, and the diameter, length and amount of the grown carbon nanofibers were almost the same as those in Example 1.

### EXAMPLE 13

A negative electrode was produced in the same manner as in Example 1, except for the use of 0.5 part by weight of nickel (II) nitrate hexahydrate and 0.5 part by weight of cobalt (II) nitrate hexahydrate instead of the 1 part by weight of nickel (II) nitrate hexahydrate. The size of nickel (II) nitrate catalyst particles and cobalt (II) nitrate catalyst particles carried on the surfaces of the SiO particles, and the diameter, length and amount of the grown carbon nanofibers were almost the same as those in Example 1.

### COMPARATIVE EXAMPLE 1

100 parts by weight of artificial graphite “SLP30 (trade name)” (available from Timcal Ltd.) (mean particle size 16 μm) was sufficiently mixed with a binder solution containing 8 parts by weight of polyvinylidene fluoride and a suitable amount of NMP, to form a negative electrode mixture paste. The binder solution used was “KF polymer #1320 (trade name)” (available from Kureha Corporation). The negative electrode mixture paste was applied onto both sides of a 15-μm-thick Cu foil serving as a current collector, dried, and rolled to obtain a negative electrode.

### COMPARATIVE EXAMPLE 2

A binder solution containing 15% by weight of a polyimide precursor was prepared by diluting a polyimide precursor solution “U-Varnish A (trade name)” (available from Ube Industries, Ltd.) with NMP.

100 parts by weight of artificial graphite was sufficiently mixed with the binder solution containing 8 parts by weight of the polyimide precursor and a suitable amount of NMP, to form a negative electrode mixture paste. The negative electrode mixture paste was applied onto both sides of a 15-μm-thick Cu foil serving as a current collector, followed by drying. The dried negative electrode mixture was heat-treated at 350° C. in argon gas, to polymerize the polyimide precursor. Thereafter, the negative electrode mixture was rolled, to obtain a negative electrode.

### COMPARATIVE EXAMPLE 3

Silicon monoxide powder (SiO powder-1) was placed into a ceramic reaction container and heated to 1000° C. in helium gas. The helium gas was then replaced with a mixture of 50% benzene gas and 50% helium gas. The internal temperature of the reaction container filled with the mixed gas was maintained at 1000° C. for 1 hour, and a carbon layer was formed on the surfaces of the SiO particles by CVD (see Journal of The Electrochemical Society, Vol. 149, A1598 (2002)). Thereafter, the mixed gas was replaced with helium gas, and the interior of the reaction container was cooled to room temperature. When the composite particles of this comparative example were analyzed with an SEM, it was confirmed that the surfaces of the SiO particles were covered with the carbon layer. The amount of the carbon layer was approximately 30% by weight of the whole composite particles of this comparative example. A negative electrode was produced in the same manner as in Example 1 except for the use of the composite particles of this comparative example.

### COMPARATIVE EXAMPLE 4

1 part by weight of nickel (II) nitrate hexahydrate was dissolved in 100 parts by weight of ion-exchange water, and the resultant solution was mixed with 5 parts by weight of acetylene black (DENKA BLACK, available from Denki Kagaku Kogyo K.K.). After this mixture was stirred for 1 hour, the water content thereof was removed in an evaporator, so that nickel (II) nitrate was carried on the acetylene black. The acetylene black with the nickel (II) nitrate carried thereon was baked at 300° C. in the air, to obtain nickel oxide particles with a size of approximately 0.1 μm.

Carbon nanofibers were grown in the same manner as in Example 1 except for the use of the nickel oxide particles thus obtained instead of the SiO particles with nickel (II) nitrate carried thereon. When the resultant carbon nanofibers were analyzed with an SEM, it was confirmed that they had a fiber diameter of approximately 80 nm and a fiber length of approximately 100 μm. The carbon nanofibers were washed with a hydrochloric acid aqueous solution to remove the nickel particles, thereby obtaining carbon nanofibers having no catalyst element.

A negative electrode was produced in the same manner as in Comparative Example 1, except for the use of a mixture of 70 parts by weight of silicon monoxide powder (SiO powder-1) and 30 parts by weight of the carbon nanofibers thus obtained instead of the 100 parts by weight of artificial graphite.

### COMPARATIVE EXAMPLE 5

A negative electrode was produced in the same manner as in Comparative Example 2, except for the use of a mixture of 70 parts by weight of silicon monoxide powder (SiO powder-1) and 30 parts by weight of carbon nonofibers produced in the same manner as in Comparative Example 4 instead of the 100 parts by weight of artificial graphite.

### COMPARATIVE EXAMPLE 6

A negative electrode was produced in the same manner as in Comparative Example 1, except for the use of composite particles produced in the same manner as in Example 1 instead of the 100 parts by weight of artificial graphite.

### COMPARATIVE EXAMPLE 7

100 parts by weight of composite particles produced in the same manner as in Example 1 were sufficiently mixed with a binder emulsion containing 5 parts by weight of styrene butadiene rubber, 3 parts by weight of carboxymethyl cellulose (CMC) serving as a thickener and a suitable amount of ion-exchange water, to form a negative electrode mixture paste. The binder emulsion used was “SB latex 0589 (trade name)” (available from JSR Corporation), and the CMC was “Cellogen 4H (trade name)” (available from Dai-ichi Kogyo Seiyaku Co., Ltd.). The negative electrode mixture paste was applied onto both sides of a 15-μm-thick Cu foil serving as a current collector, dried, and rolled to obtain a negative electrode.

### COMPARATIVE EXAMPLE 8

A negative electrode was produced in the same manner as in Comparative Example 1, except for the use of composite particles produced in the same manner as in Example 3 instead of the 100 parts by weight of artificial graphite.

[Evaluation]

(i) Production of Battery for Evaluation

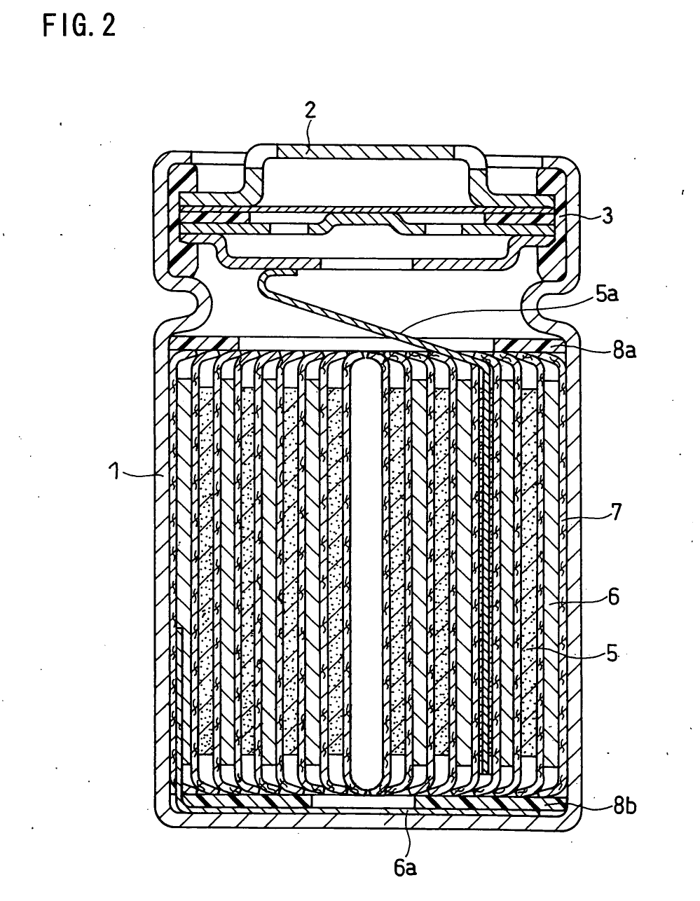

Cylindrical batteries as illustrated in FIG. 2 were produced in the following manner.

100 parts by weight of LiCoO₂ powder serving as the positive electrode active material, 10 parts by weight of acetylene black serving as a conductive agent, 8 parts by weight of polyvinylidene fluoride serving as a binder, and a suitable amount of NMP were sufficiently mixed together, to form a positive electrode mixture paste. The positive electrode mixture paste was applied onto both sides of a 20-μm-thick Al foil serving as a current collector, dried, and rolled to produce a positive electrode 5.

This positive electrode 5 and a predetermined negative electrode 6 were cut to a necessary length. Subsequently, an Al lead 5a and a Ni lead 6a were welded to the positive electrode current collector (Al foil) and the negative electrode current collector (Cu foil), respectively. The positive electrode 5 and the negative electrode 6 were wound together with a separator 7 interposed therebetween, to form an electrode assembly. As the separator 7, a 20-μm-thick micro-porous film made of polyethylene (Hipore, available from Asahi Kasei Corporation) was used.

An upper insulator plate 8a and a lower insulator plate 8b, both made of polypropylene, were mounted on and under the electrode assembly. The electrode assembly was then inserted into a battery can 1 with a diameter of 18 mm and a height of 65 mm. Thereafter, a predetermined amount of a non-aqueous electrolyte (Sol-Rite, available from Mitsubishi Chemical Corporation) was injected into the battery can 1. The non-aqueous electrolyte (not shown) is composed of a solvent mixture of ethylene carbonate and diethyl carbonate in a volume ratio of 1:1 and LiPF₆ dissolved therein at a concentration of 1 mol/L. Thereafter, the interior of the battery can 1 was evacuated to impregnate the electrode assembly with the non-aqueous electrolyte.

Lastly, a sealing plate 2 fitted with a gasket 3 was inserted into the opening of the battery can 1, and the open edge of the battery can 1 was crimped onto the circumference of the sealing plate 2, to complete a cylindrical battery (design capacity 2400 mAh).

(ii) Battery Evaluation

<a> 20° C. Cycle Characteristics

Each battery was charged and discharged at 20° C. under the following condition (1), and the initial discharge capacity C₀ at 0.2 C was checked.

Condition (1)

Constant current charge: current 480 mA (0.2 C)/end-of-charge voltage 4.2 V

Constant voltage charge: voltage 4.2 V/end-of-charge current 120 mA

Constant current discharge: current 480 mA (0.2 C)/end-of-discharge voltage 3 V

Subsequently, each battery was charged and discharged at 20° C. for 50 cycles under the following condition (2).

Condition (2)

Constant current charge: current 1680 mA (0.7 C)/end-of-charge voltage 4.2 V

Constant voltage charge: voltage 4.2 V/end-of-charge current 120 mA

Constant current discharge: current 2400 mA (1 C)/end-of-discharge voltage 3 V

After the 50 charge/discharge cycles, each battery was charged and discharged under the condition (1), and the post-cycling discharge capacity C₁ at 0.2 C was checked.

The percentage of the post-cycling discharge capacity C₁ relative to the initial discharge capacity C₀ was obtained as capacity retention rate (100×C₁/C₀).

<b> 85° C. Storage Test

This test was performed using batteries that were not used in the above evaluation of cycle characteristics. Each battery was charged at 20° C. to a battery voltage of 4.2 V at a current of 0.2 C. The charged battery was stored in a constant temperature room at 85° C. for 3 days. After the storage, the gas inside the battery was collected to determine the amount of gas produced.

<c> 130° C. Heating Test

This test was performed using batteries that were not used in the above evaluation of cycle characteristics and gas production. Each battery was charged at 20° C. to a battery voltage of 4.2 V at a current of 0.2 C. The charged battery, fitted with a thermocouple, was heated to 130° C. in a constant temperature room, and the temperature of the constant temperature room was maintained at 130° C. During this time period, the highest temperature of the battery was checked.

Table 1 shows the results. Table 1 contains the following abbreviations.
CNF: carbon nonofibers
PI: polyimide
PAI: polyamide imide
PAR: polyarylate
PEI: polyether imide
PES: polyether sulfone
APA: aramid (aromatic polyamide)
PEEK: polyether ether ketone
PVDF: polyvinylidene fluoride
SBR: styrene butadiene rubber
Grown CNF: CNF grown on the active material surface
Mixed CNF: CNF containing no catalyst element, mixed with active material

CVD: carbon layer formed on the active material surface by CVD

TABLE 1

| | | | | Evaluation | | |
|---|---|---|---|---|---|---|
| | | | | 20° C. cycle | 85° C. | 130° C. |
| | Negative electrode | | | characteristics | storage test | heating test |
| | Active | Conductive | | Capacity retention | Amount of gas | Highest temperature |
| | material | agent | Binder | rate (%) | produced (ml) | (° C.) |
| Example 1 | SiO | Grown CNF | PI | 95 | 2.1 | 130.6 |
| Example 2 | Si | Grown CNF | PI | 89 | 2.4 | 132.3 |
| Example 3 | SnO₂ | Grown CNF | PI | 92 | 2.3 | 131.8 |
| Example 4 | Ni—Si | Grown CNF | PI | 91 | 2.4 | 132.1 |
| Example 5 | Ti—Si | Grown CNF | PI | 93 | 2.2 | 130.9 |
| Example 6 | SiO | Grown CNF | PAI | 95 | 2.2 | 131.0 |
| Example 7 | SiO | Grown CNF | PAR | 93 | 2.8 | 133.7 |
| Example 8 | SiO | Grown CNF | PEI | 93 | 2.6 | 132.9 |
| Example 9 | SiO | Grown CNF | PES | 93 | 2.7 | 133.2 |
| Example 10 | SiO | Grown CNF | APA | 94 | 2.3 | 131.6 |
| Example 11 | SiO | Grown CNF | PEEK/PES | 92 | 2.6 | 133.8 |
| Example 12 | SiO | Grown CNF | PI | 95 | 2.1 | 130.7 |
| Example 13 | SiO | Grown CNF | PI | 95 | 2.1 | 130.6 |
| Comparative | Graphite | — | PVDF | 94 | 2.5 | 138.4 |
| Example 1 | | | | | | |
| Comparative | Graphite | — | PI | 95 | 3.8 | 133.1 |
| Example 2 | | | | | | |
| Comparative | SiO | CVD | PVDF | 29 | 3.3 | 132.7 |
| Example 3 | | | | | | |
| Comparative | SiO | Mixed CNF | PVDF | 32 | 3.6 | 134.1 |
| Example 4 | | | | | | |
| Comparative | SiO | Mixed CNF | PI | 35 | 3.5 | 133.3 |
| Example 5 | | | | | | |
| Comparative | SiO | Grown CNF | PVDF | 91 | 8.6 | 144.6 |
| Example 6 | | | | | | |
| Comparative | SiO | Grown CNF | SBR | 92 | 8.2 | 143.9 |
| Example 7 | | | | | | |
| Comparative | SnO₂ | Grown CNF | PVDF | 89 | 8.9 | 145.2 |
| Example 8 | | | | | | |

[Consideration]

Examples 1 to 13 and Comparative Examples 6 to 8 exhibited dramatic improvement in cycle characteristics compared with Comparative Example 3 and Comparative Examples 4 and 5. In Examples 1 to 13 and Comparative Examples 6 to 8, carbon nanofibers were grown on the active material particle. Thus, it is believed that these carbon nanofibers served to maintain the conductive network among the active material particles even when the active material underwent a volume change during charge/discharge. On the other hand, Comparative Example 3, where the active material was coated with the carbon layer, and Comparative Examples 4 and 5, where the carbon nanofibers were simply mixed with the active material, exhibited insufficient cycle characteristics.

Also, Examples 1 to 13, where highly chemically-stable, heat-resistant polymers were used as the binders, exhibited small gas production during the storage test and low highest temperatures in the heating test, regardless of the kind of the binder and the kind of the active material. Also, it can be seen that Examples 1 to 13 had improved battery reliability at high temperatures compared with Comparative Examples 6 to 8 where conventional binders were used.

It is believed that binders comprising highly chemically-stable, heat-resistant polymers do not significantly deteriorate in adhesive properties even when they are brought into contact with catalyst elements at high temperatures. It is also believed that since the binder is in contact with the catalyst element, the catalyst element is prevented from being in contact with the non-aqueous electrolyte.

The Examples using polyimide and polyamide imide, which have particularly good adhesive properties among the binders comprising heat-resistant polymers, were more effective than other Examples in heightening the battery reliability at high temperatures.

In the case of Comparative Example 2 where graphite was used as the negative electrode active material as in the related art, the highest temperature in the heating test was lower than that of Comparative Example 1 since polyimide was used as the binder; however, the amount of gas production increased. This indicates that binders comprising predetermined heat-resistant polymers produce unique effects when used in combination with the composite particles according to the present invention.

The above results have confirmed that the use of composite particles comprising a negative electrode active material comprising an element capable of being alloyed with lithium, carbon nanofibers that are grown from the surface of the negative electrode active material, and a catalyst element for promoting the growth of the carbon nanofibers can provide both high charge/discharge capacity and excellent cycle characteristics. They have also confirmed that binding such composite particles with a binder comprising a highly chemically-stable, heat-resistant polymer results in a significant improvement in battery reliability at high temperatures.

The non-aqueous electrolyte secondary battery of the present invention can provide both high charge/discharge capacity and excellent cycle characteristics while offering high reliability at high temperatures. Therefore, it is particularly useful, for example, as a power source for portable appliances or cordless appliances.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A non-aqueous electrolyte secondary battery comprising a positive electrode, a negative electrode, a separator interposed between said positive and negative electrodes, and a non-aqueous electrolyte,
wherein said negative electrode comprises composite particles and a binder,
each of said composite particles comprises: a negative electrode active material comprising an element capable of being alloyed with lithium; carbon nanofibers that are grown from a surface of said negative electrode active material; and a catalyst element for promoting the growth of the carbon nanofibers; and
said binder comprises at least one polymer selected from the group consisting of polyimide, polyamide imide, polyamide, aramid, polyarylate, polyether ether ketone, polyether imide, polyether sulfone, polysulfone, polyphenylene sulfide, and polytetrafluoroethylene.

2. The non-aqueous electrolyte secondary battery in accordance with claim 1, wherein said element capable of being alloyed with lithium is at least one selected from the group consisting of Si and Sn.

3. The non-aqueous electrolyte secondary battery in accordance with claim 1, wherein said negative electrode active material is at least one selected from the group consisting of a simple substance of silicon, a silicon oxide, a silicon alloy, a simple substance of tin, a tin oxide, and a tin alloy.

4. A negative electrode for a non-aqueous electrolyte secondary battery,
wherein said negative electrode comprises composite particles and a binder,
each of said composite particles comprises: a negative electrode active material comprising an element capable of being alloyed with lithium; carbon nanofibers that are grown from a surface of said negative electrode active material; and a catalyst element for promoting the growth of the carbon nanofibers; and
said binder comprises at least one polymer selected from the group consisting of polyimide, polyamide imide, polyamide, aramid, polyarylate, polyether ether ketone, polyether imide, polyether sulfone, polysulfone, polyphenylene sulfide, and polytetrafluoroethylene.
